(19) United States
(12) Patent Application Publication
(10) Pub. No.: US 2006/0114766 A1
(43) Pub. Date: Jun. 1, 2006

(54) Wobbling signal reproduction device

(75) Inventors: Hsiang-Ji Hsieh, Yungho City (TW); Hsueh-Kun Liao, Chu Pei City (TW); Yu-Kai Chou, Kao Hsiung City (TW)

Correspondence Address: BIRCH STEWART KOLASCH & BIRCH, PO BOX 747, FALLS CHURCH, VA, 22040-0747, US

(73) Assignee: MEDIATEK INCORPORATION

(21) Appl. No.: 11/288,318

(22) Filed: Nov. 29, 2005

(30) Foreign Application Priority Data
Nov. 30, 2004 (TW) 93136891

(51) Int. Cl. G11B 7/00

(52) U.S. Cl. 369/44.13; 369/44.28; 369/53.28

(57) ABSTRACT

A wobbling signal reproduction device has a first low-pass filter, a second low-pass filter, a first auto gain control circuit, a second auto gain control circuit, a subtraction circuit unit and a band-pass filter. The band-pass filter is connected to an output terminal of the subtraction circuit unit to eliminate noise of reflected light beams due to a recording signal during the recording process. Thus, a satisfactory wobbling signal is available.

### BACKGROUND OF THE INVENTION

1. Field of the Invention

The present invention relates to a wobbling signal reproduction device, and in particular to a signal reproduction device that can reproduce a more satisfactory wobbling signal and eliminate noise due to lower writing power during recording process.

2. Description of Related Art

Referring to FIG. 1, a spiral wobble groove of an optical disc is shown. To manufacture a blank optical disc, a glass substrate is subjected to etching process so that pre-groove 101 instead of vias are formed. The pre-groove 101 is shallow and spirally meanders from the center of the optical disc. Additionally, wobbling frequency 103 of the pre-groove 101 may vary. For example, an optical disc is recorded at a recording speed of 1×. The wobbling frequency 103 of the pre-groove 101 is 22.05 kHz. The pre-groove 101 wobbles slightly sinusoidally and the amount of wobbling 102 is approximately 0.03 μm so that the amount of wobbling 102 cannot be observed by naked eyes and must be detected by an optical device. A wobbling signal is reproduced from the pre-groove 101 by the optical device.

During the recording process, an optical pick-up head can reproduce the wobbling signal and obtain related information about the optical disc such as, for example, ATIP information. ATIP is an abbreviation of Absolute Time In Pre-groove and a time-based information that indicates the position of the optical pickup head with respect to the optical disc. The above-mentioned optical device can superimpose the wobbling signal and record data or information on the optical disc.

FIG. 2A is a block diagram of structure of an optical device and functions thereof. Referring to FIG. 2A, the block diagram includes an optical device 200 and an optical disc 201. The optical disc 201 is a blank recordable optical disc (CD-R), and the wobbling signal is formed in the optical disc 201 by an etching process. Also, the optical device 200 includes a spindle motor 202, a laser pickup head 204, a wobbling signal superimposition circuit 205, a focusing error (FE) circuit 206, a tracking error (TE) circuit 207, an Eight to Fourteen Modulation/Demodulation (EFM) modulation circuit 209, an analog laser power controller (ALPC) 220, an EFM encoder 222 and a sampling pulse generator 224. The laser pickup head 204 further includes a laser diode 211, a photodetector IC (PDIC) unit 210 and a focusing unit 212. The spindle motor 202 spins at constant velocity to rotate the optical disc, and the laser pickup head 204 moves in the radial direction of the optical disc 201 to perform a reproduction process.

As also shown in FIG. 2A, the laser pickup head 204 radiates laser beams at the optical disc 201 and receives light beams reflected from the optical disc 201. When reproducing the information recorded on the optical disc 201, the light-receiving signal includes the wobbling signal and the recorded information signal. The recorded information signal is called the EFM signal. The light-receiving signal is supplied to the EFM modulation circuit 209 and the wobbling signal superimposition circuit 205 for signal demodulation and signal superimposition. Additionally, the light-receiving signal is also supplied to the FE circuit 206 and the TE circuit 207 so as to generate a focusing error signal and a tracking error signal, respectively.

FIG. 2B schematically illustrates light-receiving surfaces of a photodetector IC unit. Referring to FIGS. 2A and 2B, the photodetector IC unit 210 of the laser pickup head 204 includes four light detection element s 210A, 210B, 210C and 210D that detect the reflected light beams from the optical disc 201. As shown in FIG. 2B, light-receiving signals (210A+210D) and (210B+210C) are detected along the radial direction of the optical disc 201.

FIG. 2C schematically shows waveforms of wobbling signals. Referring to FIGS. 2B and 2C, the four light detection element s 210A, 210B, 210C and 210D detect reflected light beams; the light detection element s 210A and 210D generate the light-receiving signal (210A+210D) and the light detection elements 210B and 210C generate the light-receiving signal (210B+210C). Two light-receiving signals (210A+210D) and (210B+210C) include a high frequency EFM signal and a low frequency wobbling signal. Low frequency wobbling signals 301A and 301B are derived from the light-receiving signals (210A+210D) and (210B+210C), respectively. Additionally, the wobbling signal 310B is subtracted from the wobbling signal 310A to generate a wobbling signal 310′. Thus, according to ATIP information of the wobbling signal 310′, the position of the laser pickup head with respect to the optical disc is available.

Reference is made to FIGS. 3A-3E. FIG. 3A shows waveforms of laser powers corresponding to mark portions and space portions during the recording process. FIG. 3B shows waveforms of reflected light beams during the recording process. FIG. 3C illustrates waveforms of light-receiving signals from the photodetector IC units during the recording process. FIG. 3D illustrates waveforms of signals from a sampling and holding circuits during the recording process. FIG. 3E illustrates waveforms of light-receiving signals from the sampling and holding circuit during the recording process. When the information is recorded on the optical disc, an EFM encoder 222 controls the ALPC 220 and laser power is adjusted in accordance with the EFM signal of the information. Then, the information is recorded on the optical disc. During the recording process, waveforms of the light-receiving signals consist of mark portions T1 and space portions T2. The laser pickup head 204 emits laser beams with recording powers in accordance with the light-receiving signals during the length of the mark portion T1, and the laser pickup head 204 emits laser beams with reproduction powers in accordance with the light-receiving signal during the length of the space portion T2. When data is recorded on the optical disc 201 (CD-R), the laser pickup head 204 emits higher power writing laser beams during the length of the mark portion T1 so as to decrease reflectivity of the optical disc 201 and perform the recording process. In addition, the laser pickup head 204 outputs a lower power reading laser beam during the length of the space portion T2 so as to perform the reproduction process. Because of variation of in laser power and reflectivity of the optical disc 201 during the length of the mark portions T1, a peak of pulse of reflected light beams occurs (as shown in level A of FIG. 3C). In the prior art, the conventional rewritable optical disc drives use a plurality of sampling and holding circuits (as shown in FIG. 4A) to reproduce light-receiving signals of the space portions T2 in accordance with recording signal generated by the EFM encoder 222. Thus, more stable reflected light signals can be available. The light-receiving signals are superimposed to generate a wobbling signal, a focusing error signal and a tracking error signal.

Referring to FIG. 4A, a conventional wobbling signal reproduction device is shown. According to FIG. 4A, outputs of first photodetector IC unit 401′A and a second photodetector IC unit 401′B of the laser pickup head 204 are, respectively, connected to output terminals of a first sampling and holding circuit 305A and a second sampling and holding circuit 305B. A sampling and holding circuit control signal 302 is used to control the first sampling and holding circuit 305A and the second sampling and holding circuit 305B. Output signals of the first photodetector IC unit 401′A and the second photodetector IC unit 401′B are sampled and held by the sampling and holding circuit control signal 302 so that the first sampling and holding circuit 305A and the second sampling and holding circuit 305B generate signals in response to the reflected light beams.

FIG. 4B illustrates a waveform diagram of light-receiving signal sampling operation. Referring to FIG. 4B, a light-receiving signal 330 includes a mark portion wobbling signal 331 and a space portion wobbling signal 332. Then, the light-receiving signal 330 is sampled by a sampling signal 350 so as to obtain a light-receiving sampling signal 334.

FIG. 4C illustrates a waveform of light-receiving signals from a photodetector IC unit. Referring to FIG. 4C, the first photodetector IC unit 401′A and the second photodetector IC unit 401′B, respectively, supply a light detection signal 331A and 331B. To generate the light detection signal 331A and 331B, a first auto gain control (AGC) circuit 310A and a second auto gain control (AGC) circuit 310B are, respectively, used to adjust gains of the light detection signal 331A and 331B so that gains of the light detection signal 331A and 331B become equal. Then, by using a subtractor 306 to perform a subtraction operation, a superimposed wobbling signal is obtained. Finally, the superimposed wobbling signal is supplied to a band pass filter 308 so that a wobbling signal is obtained.

During the recording process, if the laser pickup head 204 must be moved very correctly, a correct wobbling signal is needed. However, laser power varies in accordance with different writing strategies, and the signal to noise ratio (SNR) of the wobbling signal is not satisfactory even though the wobbling signal is subjected to a sampling and holding operation. When the recording process is performed at higher recording speed, ATIP information is not correctly decoded because of a poor wobbling signal. It results in recording failure. As shown in FIG. 4B, during the recording process, laser power of the mark portion T1 is greater that of the space portion T2. Further, the mark portion wobbling signal 331 of the mark portion T1 is also greater than that of the space portion wobbling signal 332 of the space portion T2. In this regard, if the mark portion wobbling signal 331 of the mark portion T1 can be obtained, then a satisfactory wobbling signal is available.

Laser powers at high recording speed vary quickly; if the light-receiving signal 330 is not transmitted to the first sampling and holding circuit 305A and the second sampling and holding circuit 305B, then a fast auto gain control circuit is required to adjust the light-receiving signal 330. Further, a fast subtraction circuit is needed to reduce noise of the light-receiving signal 330 because of switching between recording/reproducing laser powers. When in high frequency, if the output signals of the first sampling and holding circuit 305A and the second sampling and holding circuit 305B are out of phase due to delay, then an even greater inaccuracy will occur.

FIG. 4D illustrates waveform of saturation signals from a photodetector IC unit. Referring to FIG. 4D, the light detection elements 210A and 210D are used to generate the light-receiving signal (210A+210D), and the light detection element s 210B and 210C are used to generate the light-receiving signal (210B+210C). Due to a high recording laser power, it is likely that the photodetector IC unit 210 outputs a peak saturation signal with voltage Vₛ so that signals with voltage Vₐ and V_{b} do not have same amplitude with the auto gain control circuit. Thus, noise is not completely eliminated after a subtractor 306 performs a subtraction operation, leading to generation of a wobbling signal with a poor SNR.

### SUMMARY OF THE INVENTION

It is an object of the present invention to provide a wobbling signal reproduction device for an optical disc drive. The present invention is used to eliminate noise because writing laser power is reduced during the recording process so that a satisfactory wobbling signal is available. Specifically, the present invention uses a low-pass filter (LPF) or a band-pass filter (BPF) to filter out a peak pulse of light-receiving signals because of adjustment of laser power and variation of reflectivity of an optical disc so as to obtain a satisfactory wobbling signal.

In order to accomplish the object of the present invention, the present invention provides provide a wobbling signal reproduction device for an optical disc drive. The wobbling signal reproduction device includes a first photodetector IC unit and a second photodetector IC unit to receive light beams reflected from an optical disc. The first photodetector IC unit and the second photodetector IC unit are, respectively, connected to a first low-pass filter and a second low-pass filter. The first low-pass filter and the second low-pass filter are used to receive output signals of the first photodetector IC unit and the second photodetector IC unit, respectively, so as to generate a first low-pass signal and a second low-pass signal. A subtractor is used to receive the first low-pass signal and the second low-pass signal and performs the subtraction between the first low-pass signal and the second low-pass signal. The wobbling signal reproduction device further includes a band-pass filter.

The present invention can operate at a high frequency and does not need high frequency subtractors and high frequency auto gain control circuits. Low frequency subtractors and low frequency auto gain control circuits can be used with the present invention. Because the low-pass filter is utilized in the present invention, it is likely to eliminate noise because of light beams reflected from the optical disc during the recording process so that a satisfactory wobbling signal is available.

### BRIEF DESCRIPTION OF THE DRAWINGS

The present invention can be fully understood from the following detailed description and preferred embodiment with reference to the accompanying drawings, in which:

FIG. 1 illustrates a spiral wobble groove of an optical disc;

FIG. 2A is a block diagram of structure of an optical device and functions thereof;

FIG. 2B schematically illustrates light-receiving surfaces of a photodetector IC unit;

FIG. 2C schematically shows waveforms of wobbling signals;

FIG. 3A shows laser powers corresponding to mark portions and space portions during the recording process;

FIG. 3B shows waveforms of reflected light beams during the recording process;

FIG. 3C illustrates waveforms of light-receiving signals from the photodetector IC units during the recording process;

FIG. 3D illustrates waveforms of electrical signals from a sampling and holding circuits during the recording process;

FIG. 3E illustrates waveforms of light-receiving signals from the sampling and holding circuit during the recording process;

FIG. 4A illustrates a conventional wobbling signal reproduction device;

FIG. 4B illustrates a waveform diagram of light-receiving signal sampling operation;

FIG. 4C illustrates waveform of light-receiving signals from a photodetector IC unit;

FIG. 4D illustrates waveform of saturation signals from a photodetector IC unit;

FIG. 5A illustrates a wobbling signal reproduction device in accordance with one embodiment of the present invention;

FIG. 5B shows waveform of output signals of a low-pass filter according to the wobbling signal reproduction device of the present invention;

FIG. 6 illustrates a wobbling signal reproduction device in accordance with another embodiment of the present invention;

FIG. 7A illustrates a wobbling signal reproduction device in accordance with the third embodiment of the present invention; and

FIG. 7B is a plot showing relationship between output signals of the low-pass filter and frequency of light-receiving signals.

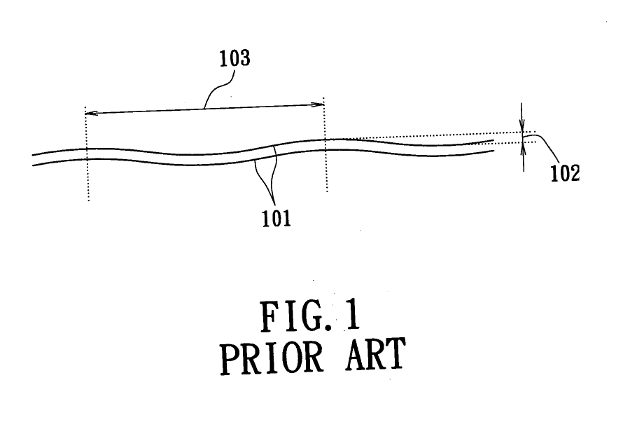

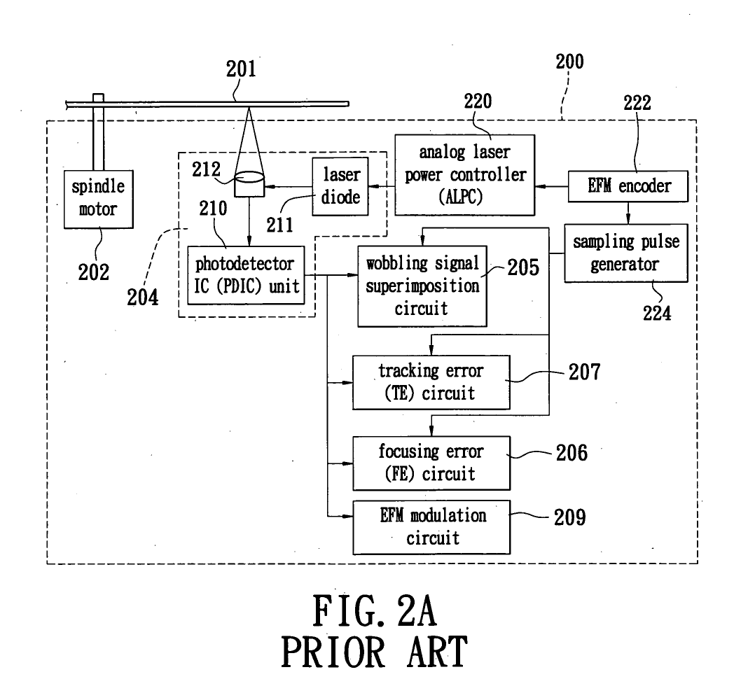

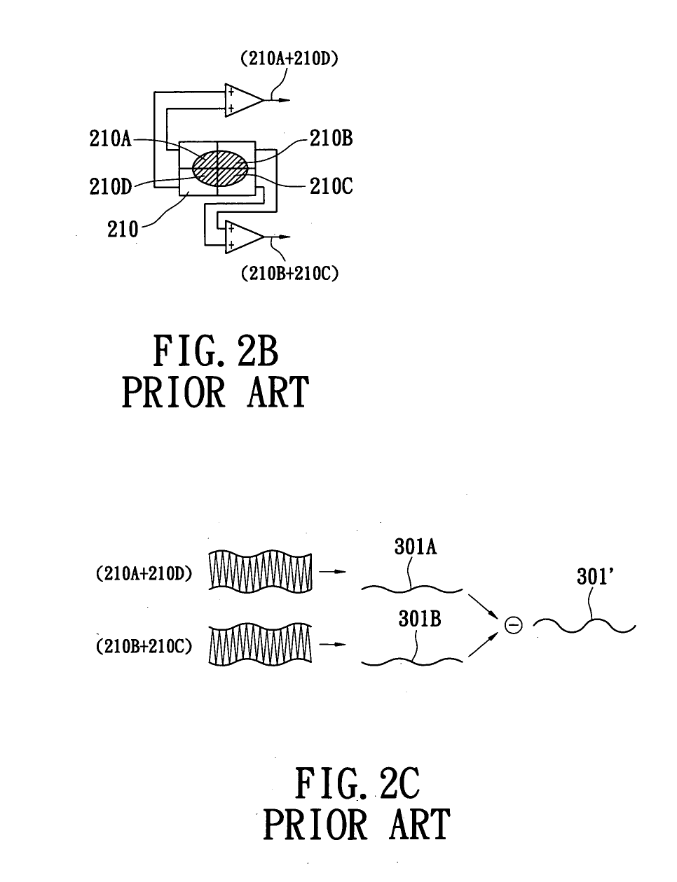

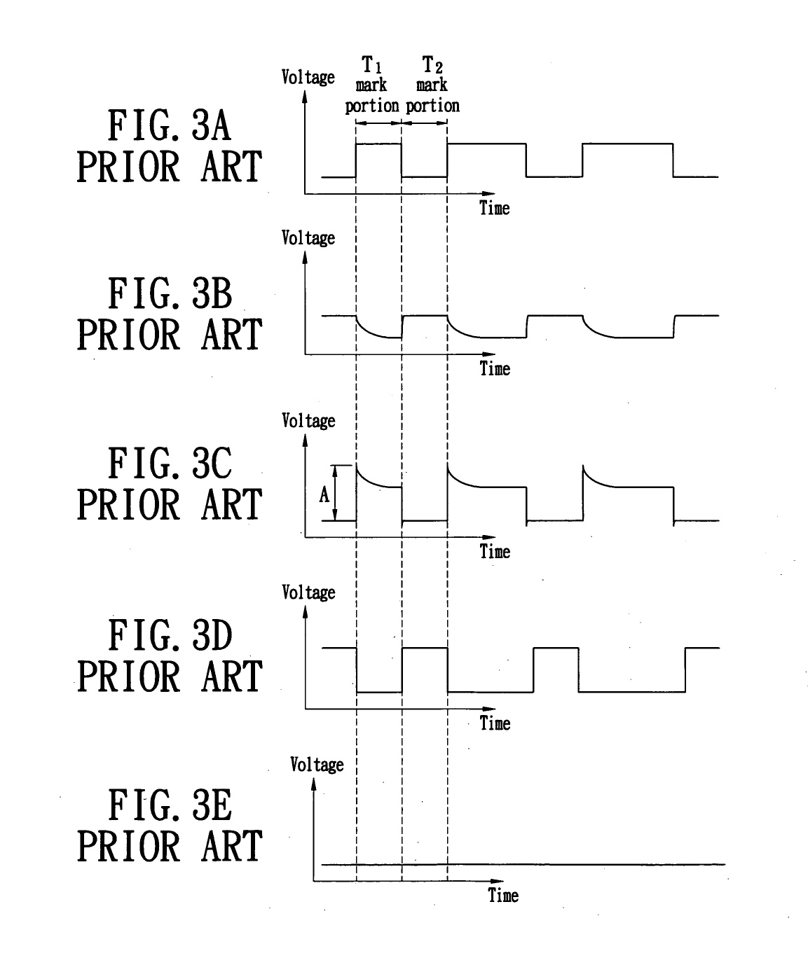

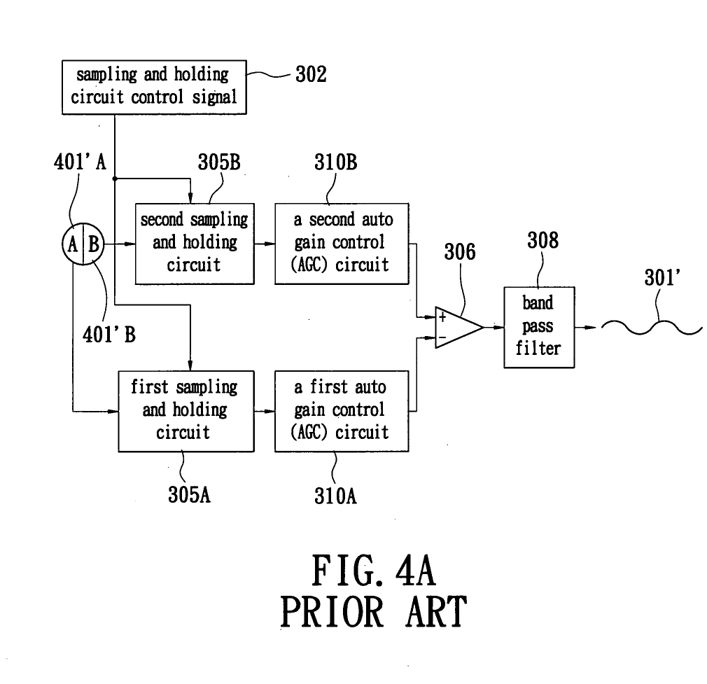

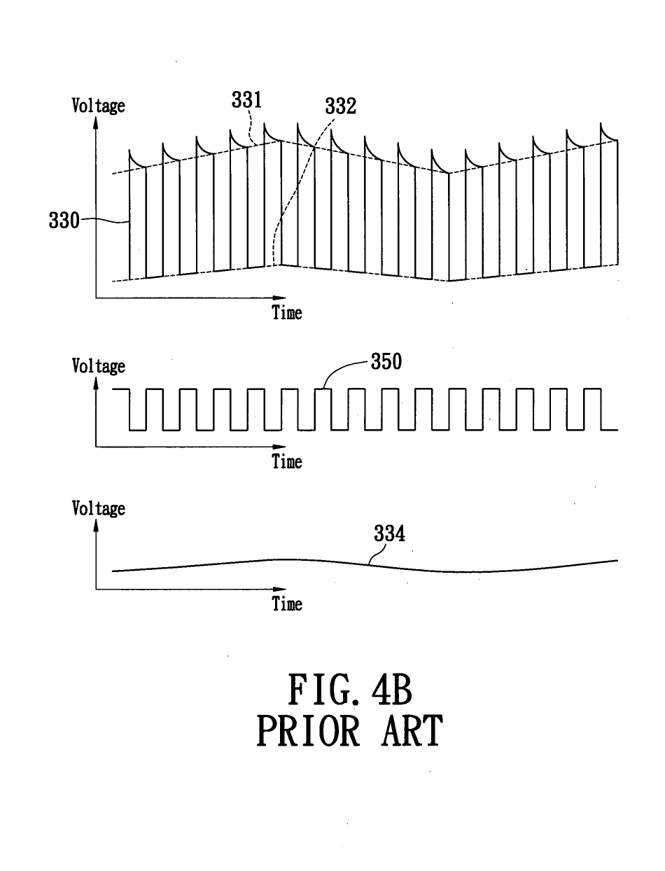

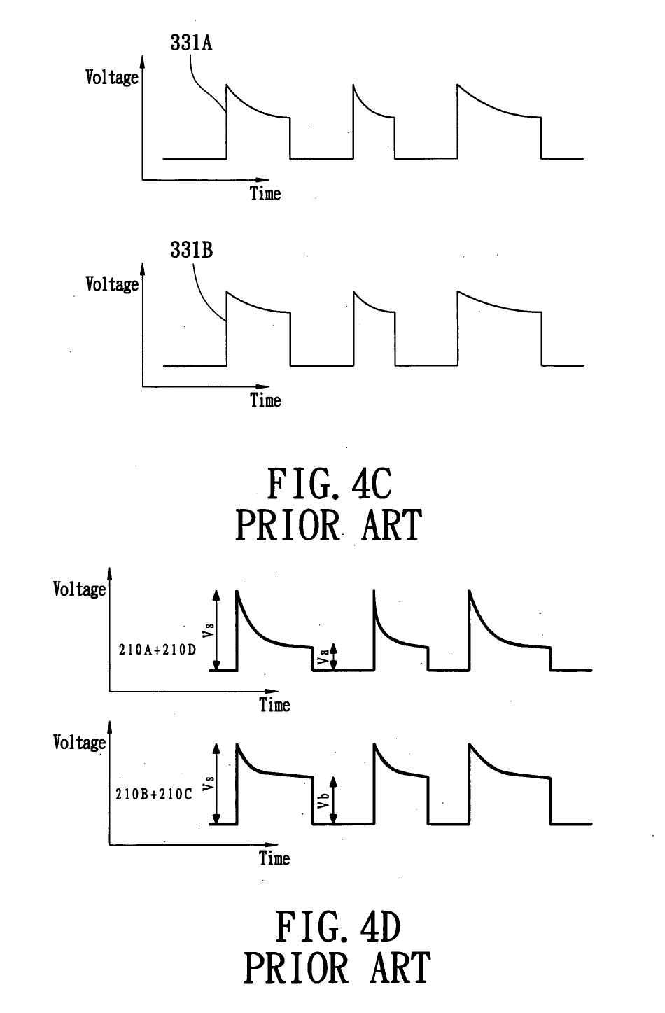

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

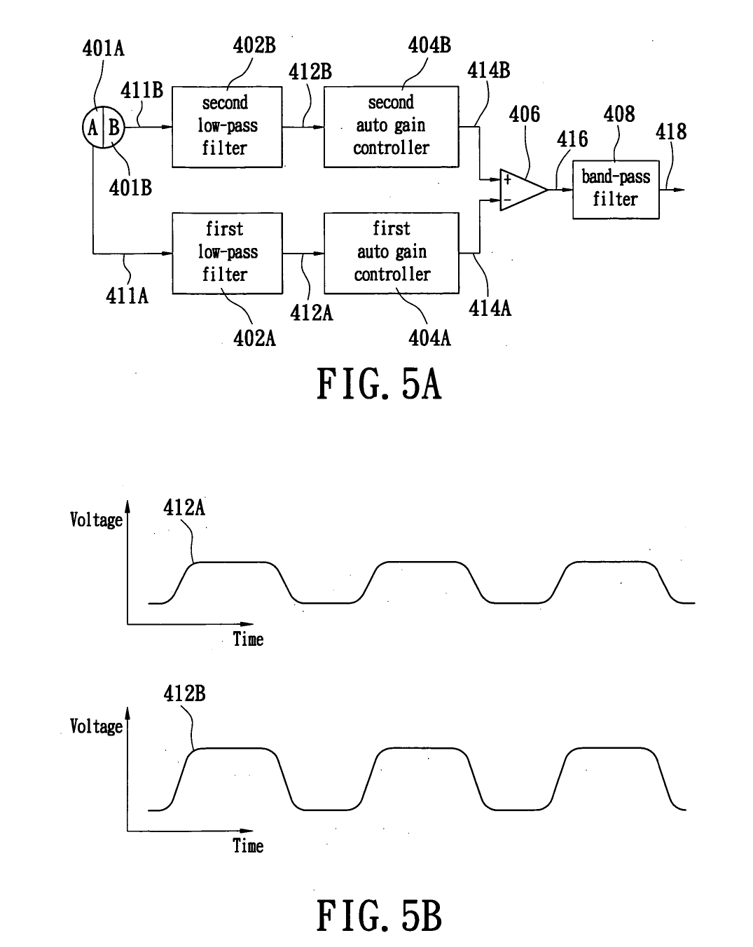

FIG. 5A illustrates a wobbling signal reproduction device according to one embodiment of the present invention. The wobbling signal reproduction device includes a first photodetector IC unit 401A and a second photodetector IC unit 401B to receive light beams reflected from an optical disc, respectively. The first photodetector IC unit 401A and the second photodetector IC unit 401B generate a first light-receiving signal 411A and a second light-receiving signal 411B, respectively. The first photodetector IC unit 401A and the second photodetector IC unit 401B are respectively connected to a first low-pass filter 402A and a second low-pass filter 402B. The first low-pass filter 402A and the second low-pass filter 402B are used to receive the first light-receiving signal 411A and the second light-receiving signal 411B so as to generate a first low-pass signal 412A and a second low-pass signal 412B.

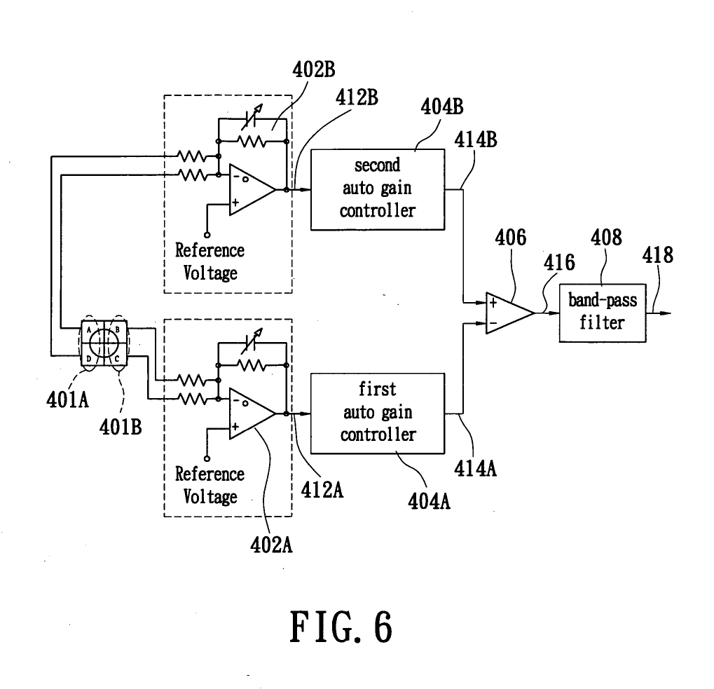

FIG. 6 shows details of a circuit in the embodiment illustrated in FIG. 5A. The first photodetector IC unit 401A and the second photodetector IC unit 401B respectively consist of quadrant elements (A+D) and (B+C). The first low-pass filter 402A and the second low-pass filter 402B can be implemented by operational amplifiers, and embodiments of the present invention are not limited to the above example and still include other equivalent circuits.

FIG. 5B shows waveform of output signals of a low-pass filter according to the wobbling signal reproduction device of the present invention. As shown in FIG. 5B, the first photodetector IC unit 401A and the second photodetector IC unit 401B generate the first low-pass signal 412A and the second low-pass signal 412B. To filter out peak pulse voltage and obtain a smooth waveform of signals, operating frequencies of the first low-pass filter 402A and the second low-pass filter 402B are adjusted.

The first photodetector IC unit 401A and the second photodetector IC unit 401B are respectively connected to a first auto gain controller 404A and a second auto gain controller 404B so as to adjust gains of the first low-pass signal 412A and the second low-pass signal 412B. Gain of the first low-pass signal 412A is equal to that of the second low-pass signal 412B. The first auto gain controller 404A and the second auto gain controller 404B output a first gain signal 414A and a second gain signal 414B, respectively. A subtraction circuit unit 406 is connected to the first auto gain controller 404A and the second auto gain controller 404B. The subtraction circuit unit 406 is used to receive the first gain signal 414A and a second gain signal 414B and perform the subtraction between the first gain signal 414A and a second gain signal 414B. In this regard, EFM signal can be eliminated and a superimposed wobbling signal 416 is available. The superimposed wobbling signal 416 is supplied to a band-pass filter 416 so as to obtain a satisfactory wobbling signal 418.

FIG. 6 illustrates a wobbling signal reproduction device in accordance with another embodiment of the present invention. Referring to FIG. 6, the first photodetector IC unit 401A and the second photodetector IC unit 401B respectively consist of quadrant elements (A+D) and (B+C). The first low-pass filter 402A and the second low-pass filter 402B can be implemented by operational amplifiers (OPA) or equivalent circuits.

According to the above-mentioned embodiments, the first low-pass filter 402A and the second low-pass filter 402B are used to filter out peak pulse voltage. The first light-receiving signal 411A and the second light-receiving signal 411B are adjusted by the first auto gain controller 404A and the second auto gain controller 404B so that the first light-receiving signal 411A and the second light-receiving signal 411B have the same amplitude. Additionally, signal noise due to variation of laser power is eliminated by the subtraction circuit unit 406.

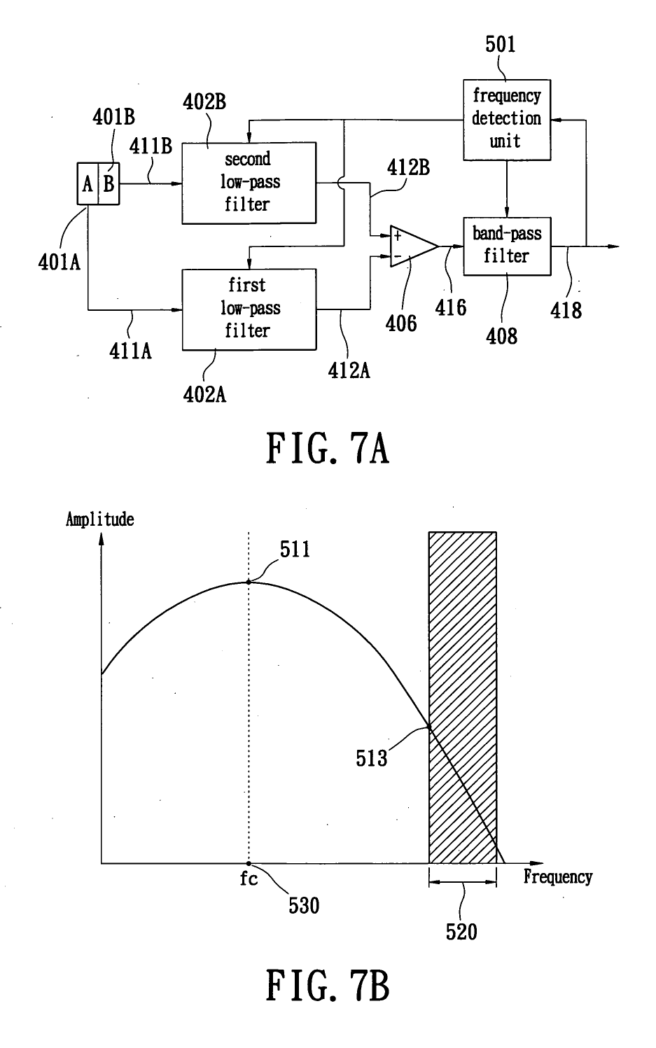

FIG. 7A illustrates a wobbling signal reproduction device in accordance with the third embodiment of the present invention. The wobbling signal device includes a first photodetector IC unit 401A and a second photodetector IC unit 410B to receive light beams reflected from an optical disc. The first photodetector IC unit 401A and a second photodetector IC unit 410B are respectively used to generate the first light-receiving signal 411A and the second light-receiving signal 411B. The first photodetector IC unit 401A and the second photodetector IC unit 401B are respectively connected to a first low-pass filter 402A and a second low-pass filter 402B. Additionally, the first low-pass filter 402A and the second low-pass filter 402B filter out the peak pulse voltage of the first light-receiving signal 411A and the second light-receiving signal 411B to generate a first low-pass signal 412A and a second low-pass signal 412B.

The subtraction circuit unit 406 is connected to output terminals of the first low-pass filter 402A and the second low-pass filter 402B so as to receive the first low-pass signal 412A and the second low-pass signal 412B. The subtraction operation is performed between the first low-pass signal 412A and the second low-pass signal 412B to eliminate EFM signal and generate a superimposed wobbling signal 416. Additionally, the superimposed wobbling signal 416 is supplied to a band-pass filter 408 so that a wobbling signal is available. Furthermore, the embodiment of the present invention also includes a frequency detection unit 501 to detect the operating frequency of the first low-pass filter 402A, the second low-pass filter 402B and the band-pass filter 408. In addition, the frequency detection unit 501 is used to control the operating frequency of the first low-pass filter 402A and the second low-pass filter 402B.

Reference is made to FIGS. 7A and 7B. FIG. 7B is a plot showing relationship between output signals of the low-pass filter and frequency of light-receiving signals. f_{c} is a cut-off frequency 530 of the first low-pass filter 402A and the second low-pass filter 402B, and the cut-off frequency 530 corresponds to a cut-off value 511 on the curve of FIG. 7B. Frequency band 520 of reflected light beams from the optical disc corresponds to a frequency band threshold 513 of reflected light beams. In this regard, the embodiment of the present invention needs the cut-off frequency of the first low-pass filter 402A and the second low-pass filter 402B, and the cut-off frequency corresponds to the cut-off value 511 and the frequency band 520 of reflected light beams corresponds to the frequency band threshold 513. The ratio of the cut-off value 511 to the frequency band threshold 513 is larger than the ratio of amplitudes of the EFM signal to the wobbling signal after the subtraction operation is performed between the first low-pass signal 412A and the second low-pass signal 412B. Only if the above condition is satisfied can light signal with peak pulse voltage be filtered out through the first low-pass filter 402A and the second low-pass filter 402B.

While the invention has been described with reference to the preferred embodiments, the description is not intended to be construed in a limiting sense. It is therefore contemplated that the appended claims will cover any such modifications or embodiments as may fall within the scope of the invention defined by the following claims and their equivalents.

What is claimed is:

1. A wobbling signal reproduction device, comprising:
a first photodetector unit and a second photodetector unit, receiving light beams reflected from an optical disc and generating a first signal and a second signal, respectively;
a first low-pass filter and a second low-pass filter, receiving the first signal and the second signal and generating a first low-pass signal and a second low-pass signal, respectively;
a first auto gain control (AGC) circuit and a second auto gain control (AGC) circuit, connected to the first low-pass filter and the second low-pass filter to adjust respectively the first low-pass signal and the second low-pass signal, adjust gains of a first gain signal and a second gain signal, and output the first gain signal and the second gain signal; and
an arithmetic unit, receiving the first gain signal and the second gain signal and subtracting the first gain signal from the second gain signal.

2. The wobbling signal reproduction device as claimed in claim 1, wherein the first low-pass filter and the second low-pass filter are used to filter out peak pulse voltage of the first signal and the second signal.

3. The wobbling signal reproduction device as claimed in claim 1, wherein the first photodetector unit and the second photodetector unit are separated and positioned on one light detection component.

4. The wobbling signal reproduction device as claimed in claim 1, wherein the arithmetic unit subtracts the first gain signal from the second gain signal to generate and supply a superimposed wobbling signal to a band-pass filter and generate a wobbling signal.

5. The wobbling signal reproduction device as claimed in claim 4, wherein another auto gain control circuit is connected between the arithmetic unit and the band-pass filter.

6. A wobbling signal reproduction device, comprising:
a first photodetector unit and a second photodetector unit, receiving light beams reflected from an optical disc and generating a first signal and a second signal, respectively;
a first low-pass filter and a second low-pass filter, receiving the first signal and the second signal and generating a first low-pass signal and a second low-pass signal, respectively;
an arithmetic unit, receiving the first gain signal and the second gain signal and subtracting the first gain signal from the second gain signal; and
a low-pass filter, connected to an output terminal of the arithmetic unit.

7. The wobbling signal reproduction device as claimed in claim 6, wherein the first low-pass filter and the second low-pass filter are used to filter out a peak pulse voltage of the first signal and a second signal.

8. The wobbling signal reproduction device as claimed in claim 6, wherein the arithmetic unit subtracts the first gain signal from the second gain signal to generate and supply a superimposed wobbling signal to a band-pass filter and generate a wobbling signal.

9. The wobbling signal reproduction device as claimed in claim 6, further comprising a frequency detection unit to detect a frequency of the wobbling signal, and adjusting the operating frequency of the first low-pass filter, the second low-pass filter and the band-pass filter in response to the frequency of the wobbling signal.

10. The wobbling signal reproduction device as claimed in claim 6, wherein the operational amplifier is a band-pass filter.

11. A wobbling signal reproduction device, comprising:
a plurality of photodetector units, receiving light beams reflected from an optical disc;
a plurality of low-pass filters, connected to output terminals of photodetector units and handling signals and generating a plurality of low-pass signals;
an arithmetic unit, used to receive a plurality of low-pass signals and generate an arithmetic signal; and
a low-pass filter, receiving the arithmetic signal and generating the wobbling signal.

12. The wobbling signal reproduction device as claimed in claim 11, wherein the arithmetic unit further comprises a plurality of auto gain control circuits to adjust gains of auto gain control circuits and equalize amplitudes of signals due to variation of laser power.

13. The wobbling signal reproduction device as claimed in claim 11, further comprising a frequency detection unit to detect the frequency of the wobbling signal, and adjust an operating frequency of a plurality of low-pass filters and the band-pass filter in response to the frequency of the wobbling signal.
